(19) United States
(12) Patent Application Publication
(10) Pub. No.: US 2024/0151422 A1
(43) Pub. Date: May 9, 2024

(54) METHOD AND DEVICE FOR CONTROLLING ICE STORAGE AIR-CONDITIONING SYSTEM, AND ELECTRONIC EQUIPMENT

(71) Applicants: Shanghai Kong Intelligent Building Co., Ltd, Shanghai (CN); GD Midea Heating & Ventilating Equipment Co., Ltd., Foshan (CN)

(72) Inventors: Xing FANG, Shanghai (CN); Yuanyang LI, Shanghai (CN); Yide QIU, Shanghai (CN); Jie FEI, Shanghai (CN); Cong WANG, Shanghai (CN)

(21) Appl. No.: 18/517,593

(22) Filed: Nov. 22, 2023

Related U.S. Application Data
(63) Continuation of application No. PCT/CN2022/136337, filed on Dec. 2, 2022.

(30) Foreign Application Priority Data
Dec. 27, 2021 (CN) 202111616407.3
Dec. 27, 2021 (CN) 202111619177.6

(51) Int. Cl. F24F 11/64; F24F 5/00; F24F 11/85

(52) U.S. Cl. CPC F24F 11/64; F24F 5/0017; F24F 11/85; F24F 2005/0032

(57) ABSTRACT

A method for controlling an ice storage air-conditioning system includes: adjusting parameters of the ice storage air-conditioning system in a current cooling mode or when switching a cooling mode based on an outlet temperature of a plate heat exchanger of the ice storage air-conditioning system; and controlling the ice storage air-conditioning system to perform a cooling operation based on the parameters of the ice storage air-conditioning system.

### CROSS-REFERENCE TO RELATED APPLICATIONS

This application is a continuation application of the International Application No. PCT/CN2022/136337 filed on Dec. 2, 2022, which claims priority to and benefits of Chinese Patent Applications No. 202111619177.6, and No. 202111616407.3, both filed on Dec. 27, 2021, the entire contents of which are incorporated herein by reference.

### TECHNICAL FIELD

The present disclosure relates to the field of air conditioning systems, and in particular, to a method and a device for controlling an ice storage air-conditioning system.

### BACKGROUND

Ice storage air-conditioning systems remove heat from a cold storage medium during times when no or little cooling capacity is needed (such as at night), and then the stored cooling capacity is utilized during peak periods of air conditioning or industrial cooling. Through the application of ice storage technology, the operation period of refrigeration equipment can be shifted. Cheap electricity at night can be used, and the peak electricity load during the day can be reduced, allowing the shifting power peaks and valleys and also may help to reduce electricity bills. The ice storage air-conditioning system benefits from ensuring the stability of supply water temperature in a switching process of the dual duty chiller and the ice tank.

The ice storage air-conditioning system may determine an operation mode of the cold source equipment (e.g., an ice tank cooling mode, a dual-condition chiller cooling mode and a combined cooling mode) according to an electricity price in a current period. During a mode switch process, a delay in switching on and switching off a water chilling unit, may not allow a stable control for the water temperature. Places such as factories and laboratories may have strict requirements on temperature and humidity, where a fluctuation range of the supply water temperature is usually required to not exceed ±0.5° C. A switch control logic of the ice storage air-conditioning system may lead to a large fluctuation range of an outlet water temperature, which may affect users' experience.

### SUMMARY

In view of this, some embodiments of the present disclosure provide a method and a device for controlling an ice storage air-conditioning system, and a piece of electronic equipment, to ensure a stable outlet water temperature in the ice storage air-conditioning system and improve the user's experience.

In accordance with some embodiments of the present disclosure, a method for controlling an ice storage air-conditioning system is provided, which is applied to a controller of the ice storage air-conditioning system. The method includes: adjusting parameters of the ice storage air-conditioning system in a current cooling mode based on an outlet temperature of a plate heat exchanger of the ice storage air-conditioning system; and controlling the ice storage air-conditioning system to perform a cooling operation based on the parameters of the ice storage air-conditioning system.

In some embodiments, the current cooling mode of the above ice storage air-conditioning system may be a dual-condition chiller cooling mode; and adjusting the parameters of the ice storage air-conditioning system in the current cooling mode based on the outlet temperature of the plate heat exchanger of the ice storage air-conditioning system includes steps of: determining a number of operating water chilling units of the ice storage air-conditioning system based on an outlet water temperature and a current load rate of the ice storage air-conditioning system; determining a number of operating chilled water pumps of the ice storage air-conditioning system to be the same as the number of operating water chilling units; and adjusting an operation frequency of the chilled water pump based on the outlet temperature of the plate heat exchanger of the ice storage air-conditioning system.

In some embodiments, adjusting the parameters of the ice storage air-conditioning system in the current cooling mode based on the outlet temperature of the plate heat exchanger of the ice storage air-conditioning system may include steps of: in accordance with a determination that the outlet temperature of the plate heat exchanger is greater than a sum of the target temperature and a preset first deviation value, obtaining a target temperature of the ice storage air-conditioning system; increasing the operation frequency of the chilled water pump; and in accordance with a determination that the outlet temperature of the plate heat exchanger is smaller than a difference value between the target temperature and the preset first deviation value, reducing the operation frequency of the chilled water pump.

In some embodiments, the current cooling mode of the above ice storage air-conditioning system is an ice-storage tank cooling mode; adjusting the parameters of the ice storage air-conditioning system in the current cooling mode based on the outlet temperature of the plate heat exchanger of the ice storage air-conditioning system, may include at least one of the following: adjusting an opening degree of a valve of an ice storage tank in the ice storage air-conditioning system based on the outlet temperature of the plate heat exchanger of the ice storage air-conditioning system; adjusting an operation frequency of a chilled water pump based on the outlet temperature of the plate heat exchanger of the ice storage air-conditioning system; and adjusting a number of operating chilled water pumps based on the outlet temperature of the plate heat exchanger of the ice storage air-conditioning system.

In some embodiments, adjusting the opening degree of the valve of the ice storage tank in the ice storage air-conditioning system based on the outlet temperature of the plate heat exchanger of the ice storage air-conditioning system may include steps of: in accordance with a determination that the outlet temperature of the plate heat exchanger is greater than a sum of a target temperature and a preset second deviation value, increasing the opening degree of the valve of the ice storage tank; and in accordance with a determination that the outlet temperature of the plate heat exchanger is smaller than a difference value between the target temperature and the preset second deviation value, reducing the opening degree of the valve of the ice storage tank. The step of adjusting the number of operating chilled water pumps based on the outlet temperature of the plate heat exchanger of the ice storage air-conditioning system includes steps of: in accordance with a determination that the outlet temperature of the plate heat exchanger is greater than a sum of the target temperature and a preset third deviation value, increasing the number of operating chilled water pumps; and in accordance with a determination that the outlet temperature of the plate heat exchanger is smaller than a difference value between the target temperature and the preset third deviation value, reducing the number of operating chilled water pumps.

In some embodiments, the current cooling mode of the above ice storage air-conditioning system is a combined cooling mode with a dual duty chiller and an ice storage tank; adjusting the parameters of the ice storage air-conditioning system in the current cooling mode based on the outlet temperature of the plate heat exchanger of the ice storage air-conditioning system may include steps of: determining a number of operating water chilling units of the ice storage air-conditioning system based on an outlet water temperature and a current load rate of the ice storage air-conditioning system; determining a number of operating chilled water pumps of the ice storage air-conditioning system to be the same as the number of operating water chilling units; adjust an opening degree of a valve of an ice storage tank in the ice storage air-conditioning system based on the outlet temperature of the plate heat exchanger of the ice storage air-conditioning system; and in accordance with a determination that the opening degree of the valve is adjusted to a preset limit of the opening degree, adjusting an operation frequency of the chilled water pump based on the outlet temperature of the plate heat exchanger of the ice storage air-conditioning system.

In some embodiments, in accordance with a determination that the opening degree of the valve is adjusted to a preset limit of the opening degree, adjusting an operation frequency of the chilled water pump based on the outlet temperature of the plate heat exchanger of the ice storage air-conditioning system may include steps of: in accordance with a determination that the opening degree of the valve is increased to a preset upper limit of the opening degree, increasing the operation frequency of the chilled water pump based on the outlet temperature of the plate heat exchanger of the ice storage air-conditioning system; and in accordance with a determination that the opening degree of the valve is reduced to a preset lower limit of the opening degree, reducing the operation frequency of the chilled water pump based on the outlet temperature of the plate heat exchanger of the ice storage air-conditioning system.

In some embodiments, the above method may also include a step of: determining the current cooling mode of the ice storage air-conditioning system based on a current power time period and/or an ice amount in an ice storage tank of the ice storage air-conditioning system.

In some embodiments, determining the current cooling mode of the ice storage air-conditioning system based on the current power time period and/or the ice amount in the ice storage tank of the ice storage air-conditioning system may include steps of: in accordance with a determination that the current power time period is in a power wave flat period or the ice amount in the ice storage tank of the ice storage air-conditioning system is smaller than a preset first threshold, determining that the current cooling mode of the ice storage air-conditioning system is a dual-condition chiller cooling mode; determining that the current cooling mode of the ice storage air-conditioning system is an ice-storage tank cooling mode in accordance with a determination that the current power time period is in a power wave peak period, and the ice amount in the ice storage tank of the ice storage air-conditioning system is greater than a preset second threshold; and in accordance with a determination that the current power time period is in the power wave peak period and the ice amount in the ice storage tank of the ice storage air-conditioning system is smaller than a preset third threshold, or the current power time period is in the power wave flat period and the ice amount in the ice storage tank of the ice storage air-conditioning system is greater than a preset fourth threshold, determining that the current cooling mode of the ice storage air-conditioning system is a combined cooling mode with a dual duty chiller and the ice storage tank.

In accordance with some embodiments of the present disclosure, a device for controlling an ice storage air-conditioning system is also provided, which is applied to a controller of the ice storage air-conditioning system. The device includes: a cooling parameter determination module, which is configured to adjust parameters of the ice storage air-conditioning system in a current cooling mode based on an outlet temperature of a plate heat exchanger of the ice storage air-conditioning system; and a cooling operation execution module, which is configured to control the ice storage air-conditioning system to perform a cooling operation based on the parameters of the ice storage air-conditioning system.

In accordance with other embodiments of the present disclosure, a method for controlling an ice storage air-conditioning system is also provided, which is applied to a controller of an ice storage air-conditioning system. The method includes adjusting parameters of the ice storage air-conditioning system when switching a cooling mode based on an outlet temperature of a plate heat exchanger of the ice storage air-conditioning system; and controlling the ice storage air-conditioning system to perform a cooling operation based on the parameters of the ice storage air-conditioning system.

In some embodiments, the cooling mode of the ice storage air-conditioning system is switched from a dual-condition chiller cooling mode to an ice-storage tank cooling mode; adjusting the parameters of the ice storage air-conditioning system when switching the cooling mode based on the outlet temperature of the plate heat exchanger of the ice storage air-conditioning system may include steps of: maintaining a working status of the chilled water pump of the ice storage air-conditioning system, and adjusting a valve of an ice storage tank in the ice storage air-conditioning system and a regulating valve of the plate heat exchanger; where an opening degree of the valve of the ice storage tank and an opening degree of the regulating valve of the plate heat exchanger are determined both based on the outlet temperature of the plate heat exchanger; and switching off a water chilling unit, a cooling water pump and a cooling water tower of the ice storage air-conditioning system.

In some embodiments, the cooling mode of the ice storage air-conditioning system is switched from the ice-storage tank cooling mode to the dual-condition chiller cooling mode; adjusting the parameters of the ice storage air-conditioning system when switching the cooling mode based on the outlet temperature of the plate heat exchanger of the ice storage air-conditioning system may include steps of: determining a number of operating water chilling units of the ice storage air-conditioning system after a mode switching; switching on the number of operating water chilling units, cooling water pumps and cooling water towers; and adjusting an opening degree of a valve of an ice storage tank in the ice storage air-conditioning system based on an outlet water temperature of the water chilling unit and the outlet temperature of the plate heat exchanger.

In some embodiments, determining the number of operating water chilling units of the ice storage air-conditioning system after mode switching may include steps of: obtaining a load of the ice storage air-conditioning system before the mode switching; determining a predicted load of the ice storage air-conditioning system after the mode switching based on the load before switching and a pre-established load prediction model; and determining the number of operating water chilling units of the ice storage air-conditioning system after the mode switching based on the predicted load after the mode switching.

In some embodiments, adjusting the opening degree of the valve of the ice storage tank in the ice storage air-conditioning system based on the outlet temperature of the chiller and the outlet temperature of the plate heat exchanger includes steps of: obtaining an actual load of the ice storage air-conditioning system after the mode switching; in accordance with a determination that a value obtained by subtracting the outlet water temperature of the water chilling unit with the outlet temperature of the plate heat exchanger is greater than a preset first threshold, or a ratio of the predicted load to the actual load after the mode switching is smaller than a preset ratio threshold, increasing the opening degree of the valve of the ice storage tank in the ice storage air-conditioning system; in accordance with a determination that the ratio of the predicted load to the actual load after mode switching is greater than the preset ratio threshold, reducing the opening degree of the valve of the ice storage tank in the ice storage air-conditioning system; and in accordance with a determination that an absolute value of a difference value between the outlet water temperature of the water chilling unit and the outlet temperature of the plate heat exchanger is smaller than a preset second threshold, closing the valve of the ice storage tank in the ice storage air-conditioning system.

In some embodiments, reducing the opening degree of the valve of the ice storage tank in the ice storage air-conditioning system includes determining the opening degree of the valve of the ice storage tank in the ice storage air-conditioning system through the following formula: V1,ub=(Tch,out−Tice,out)/(Tch,out−T3+Tcomp); where, V1,ub is an upper limit of the opening degree of the valve of the ice storage tank in the ice storage air-conditioning system, Tch,out is the outlet water temperature of the water chilling unit, and Tice,out is an outlet water temperature of the ice storage tank, T3 is the outlet temperature of the plate heat exchanger, and Tcomp is a preset compensation temperature.

In some embodiments, the above method may further include switching a cooling mode of the ice storage air-conditioning system based on a current power time period and/or an ice amount in an ice storage tank of the ice storage air-conditioning system.

In some embodiments, switching the cooling mode of the ice storage air-conditioning system may include a step of: switching the cooling mode of the ice storage air-conditioning system from a dual-condition chiller cooling mode to an ice-storage tank cooling mode; or alternatively, switching the cooling mode of the ice storage air-conditioning system from the ice-storage tank cooling mode to the dual-condition chiller cooling mode.

In accordance with some embodiments of the present disclosure, a control device for an ice storage air-conditioning system is also provided, which is applied to a controller of the ice storage air-conditioning system. The device includes: a cooling parameter determination module, which is configured to adjust parameters of the ice storage air-conditioning system when switching a cooling mode based on an outlet temperature of a plate heat exchanger of the ice storage air-conditioning system; and a cooling operation execution module, which is configured to control the ice storage air-conditioning system to perform a cooling operation based on the parameters of the ice storage air-conditioning system.

In accordance with some embodiments of the present disclosure a piece of electronic equipment is also provided, which includes a processor and a memory. The memory stores computer-executable instructions that are executable by the processor, and the processor, when executing the computer-executable instructions is configured to implement the method for controlling the ice storage air-conditioning system of some embodiments and/or the method for controlling the ice storage air-conditioning system of other embodiments of the present disclosure as described above.

In accordance with some embodiments of the present disclosure, a computer-readable storage medium is also provided, which stores computer-executable instructions that, when invoked and executed by a processor, cause the processor to implement the method for controlling the ice storage air-conditioning system in some embodiments of the present disclosure and/or the method for controlling the ice storage air-conditioning system in other embodiments of the present disclosure. as described above.

Other features and advantages of the present disclosure will be set forth in the subsequent description, or some of the features and advantages may be inferred or unambiguously determined from the description, or may be learned by practicing the above techniques of the present disclosure.

In order to make the above objectives, features and advantages of the present disclosure more obvious and comprehensible, preferred embodiments are given below and described in detail with reference to the accompanying drawings.

### BRIEF DESCRIPTION OF DRAWINGS

FIG. 1 is a schematic diagram of an ice storage air-conditioning system according to an embodiment of the present disclosure;

FIG. 2 is a flowchart of a method for controlling an ice storage air-conditioning system according to some embodiments of the present disclosure;

FIG. 3 is a flowchart of another method for controlling the ice storage air-conditioning system according to some embodiments of the present disclosure;

FIG. 4 is a schematic diagram of determining a cooling mode of an ice storage system according to some embodiments of the present disclosure;

FIG. 5 is a schematic diagram of a control process for pumps and valves in a dual-condition chiller cooling mode according to some embodiments of the present disclosure;

FIG. 6 is a schematic diagram of a control process for pumps and valves in an ice-storage tank cooling mode according to some embodiments of the present disclosure;

FIG. 7 is a schematic diagram of a control process for pumps and valves in a combined cooling mode of the dual duty chiller and the ice storage tank according to some embodiments of the present disclosure;

FIG. 8 is a schematic structural diagram of a device for controlling an ice storage air-conditioning system according to some embodiments of the present disclosure;

FIG. 9 is a flowchart of a method for controlling an ice storage air-conditioning system according to other embodiments of the present disclosure;

FIG. 10 is a flowchart of another method for controlling the ice storage air-conditioning system according to other embodiments of the present disclosure;

FIG. 11 is a schematic diagram of a control process for switching the dual-condition chiller cooling mode to the ice-storage tank cooling mode according to other embodiments of the present disclosure;

FIG. 12 is a schematic diagram of a control process for switching the ice-storage tank cooling mode to a dual-condition chiller cooling mode according to other embodiments of the present disclosure;

FIG. 13 is a schematic structural diagram of a device for controlling an ice storage air-conditioning system according to other embodiments of the present disclosure; and

FIG. 14 is a schematic structural diagram of a piece of electronic equipment according to some embodiments of the present disclosure.

### DETAILED DESCRIPTION OF EMBODIMENTS

At present, the ice storage air-conditioning system will determine an operation mode of cold source equipment according to an electricity price in the current period, such as an ice-storage tank cooling mode, a dual-condition chiller cooling mode and a combined cooling mode. During a mode switch process, due to a delay in switching on and switching off a water chilling unit, the traditional control strategy cannot ensure a stable control for water temperature. Especially for places such as factories and laboratories that have strict requirements on temperature and humidity, where a fluctuation range of the supply water temperature is usually required to not exceed ±0.5° C. A switch control logic of the ice storage air-conditioning system will cause the outlet water temperature to fluctuate in a large range, affecting users' experience.

On the basis of this, some embodiments of the present disclosure provide a control method and a control device for an ice storage air-conditioning system, particularly, related to an intelligent and undisturbed method for controlling an ice storage air-conditioning system, which can ensure a stable control of an outlet temperature of chilled water for plate replacement while minimizing an energy consumption of the chilled water pump.

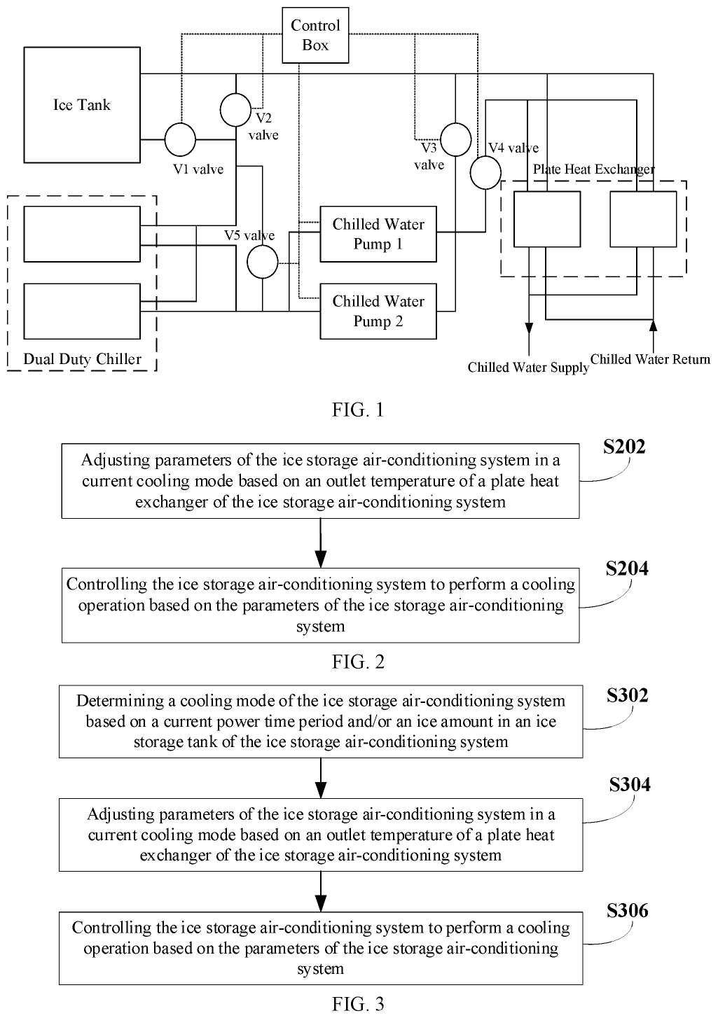

To facilitate understanding of this embodiment, a method for controlling an ice storage air-conditioning system according to some embodiments of the present disclosure is first introduced in detail with reference to FIGS. 1 to 7.

According to an embodiment of the present disclosure, a method for controlling an ice storage air-conditioning system is provided, which is applied to a controller of the ice storage air-conditioning system.

Ice storage technology is a complete set of technology that takes advantage of the low-peak hours of the power grid at night and uses low-priced electricity to make ice storage to store a cooling capacity. During the daytime when electricity consumption is at peak, the dissolved water is used together with the refrigeration unit to provide cooling. During a peak load of the air conditioner in the daytime, the stored cooling capacity is released to meet the peak load needs of air conditioning.

FIG. 1 shows a schematic diagram of an ice storage air-conditioning system. Referring to FIG. 1, the ice storage air-conditioning system includes an ice tank (which can also be called an ice storage tank), a dual duty chiller (that is, a water chilling unit having two chillers), two chilled water pumps, two plate heat exchangers and one control box (that is, a controller of the ice storage air-conditioning system), a passage of each apparatus is adjustable through valves V1-V5. Among them, the control box can control each valve and two chilled water pumps.

The cooling modes of the ice storage air-conditioning system shown in the figure may include a dual-condition chiller cooling mode, an ice-storage tank cooling mode, and a combined cooling mode of a dual duty chiller and an ice storage tank. Particularly, the dual-condition chiller cooling mode is that the water chilling unit is used to provide cooling, and the ice storage tank does not provide cooling. The ice-storage tank cooling mode is that the ice storage tank is used to provide cooling, and the water chilling unit does not provide cooling. The combined cooling mode of the dual duty chiller and the ice storage tank is that the ice storage tank and the water chilling unit are both used to provide cooling.

Based on the above description, referring to the flowchart of a method for controlling an ice storage air-conditioning system according to an embodiment of the present disclosure shown in FIG. 2, the method for controlling the ice storage air-conditioning system may include the following steps S202 and S204.

In step S202, parameters of the ice storage air-conditioning system in a current cooling mode are adjusted based on an outlet temperature of a plate heat exchanger of the ice storage air-conditioning system.

In step S204, the ice storage air-conditioning system is controlled to perform a cooling operation based on the parameters of the ice storage air-conditioning system.

In embodiments according to the present disclosure, the parameters of the ice storage air-conditioning system in each cooling mode can be adjusted at any time according to the outlet temperature of the plate heat exchanger of the ice storage air-conditioning system. Particularly, the parameters of the ice storage air-conditioning system may include an opening degree of each valve (i.e., the V1 valve to V5 valve in FIG. 1) and an operation frequency of the chilled water pump.

After the parameters of the ice storage air-conditioning system are determined based on the outlet temperature of the plate heat exchanger, the ice storage air-conditioning system may be controlled to perform the cooling operation based on the parameters of the ice storage air-conditioning system, so as to ensure that the supply water temperature of the ice storage air-conditioning system has small fluctuations and improve the user's experience.

According to the method for controlling the ice storage air-conditioning system provided by the embodiment of the present disclosure as shown in FIG. 2, the current cooling mode can be adjusted based on the outlet temperature of the plate heat exchanger of the ice storage air-conditioning system, and the ice storage air-conditioning system is controlled to perform the cooling operation based on the parameters of the ice storage air-conditioning system. In this method, the parameters of the ice storage air-conditioning system in the current cooling mode can be adjusted based on the outlet temperature of the plate heat exchanger, thereby a stable outlet water temperature in the ice storage air-conditioning system can be ensured and the user's experience can be improved.

Referring now to FIG. 3. The embodiment shown in FIG. 3 provides another method for controlling the ice storage air-conditioning system, which is implemented based on the embodiment shown in FIG. 2. As shown in the flowchart of another method for controlling the ice storage air-conditioning system in FIG. 3, the method for controlling the ice storage air-conditioning system in this embodiment may include the following steps S302, S304 and S306.

In step S302, a cooling mode of the ice storage air-conditioning system is determined based on a current power time period and/or an ice amount in the ice storage tank of the ice storage air-conditioning system.

In step S304, parameters of the ice storage air-conditioning system are adjusted in the current cooling mode based on qn outlet temperature of a plate heat exchanger of the ice storage air-conditioning system.

In step S306, the ice storage air-conditioning system is controlled to perform a cooling operation based on the parameters of the ice storage air-conditioning system.

The power time period may include a power wave flat period and a power wave peak period. Among them, the power wave flat period is generally 22:00-8:00, and the power wave peak period is generally 08:00-22:00. That is to say, the late-night period is the power wave flat period, and the daytime period is the power wave peak period. The ice amount in the ice storage tank of the ice storage air-conditioning system is the amount of ice stored in the ice storage tank. Only when the amount of ice stored in the ice storage tank is large, the ice storage tank can be used for cooling. Hence, the cooling mode of the ice storage air-conditioning system can be determined based on the current power time period and the ice amount in the ice storage tank of the ice storage air-conditioning system.

Particularly, in step S302, the current cooling mode of the ice storage air-conditioning system may be determined through the following steps: determining that the current cooling mode of the ice storage air-conditioning system is the dual-condition chiller cooling mode in accordance with a determination that the current power time period is in the power wave flat period, or the ice amount in the ice storage tank of the ice storage air-conditioning system is smaller than a preset first threshold; determining that the cooling mode of the ice storage air-conditioning system is the ice-storage tank cooling mode in accordance with a determination that the current power time period is in the power wave peak period, and the ice amount in the ice storage tank of the ice storage air-conditioning system is greater than a preset second threshold value; and determining that the current cooling mode of the ice storage air-conditioning system is the combined cooling mode of the dual duty chiller and the ice storage tank in accordance with a determination that the current power time period is in the power wave peak period and the ice amount in the ice storage tank of the ice storage air-conditioning system is smaller than a preset third threshold, or the current power time period is in the power wave flat period and the ice amount in the ice storage tank of the ice storage air-conditioning system is greater than a preset fourth threshold.

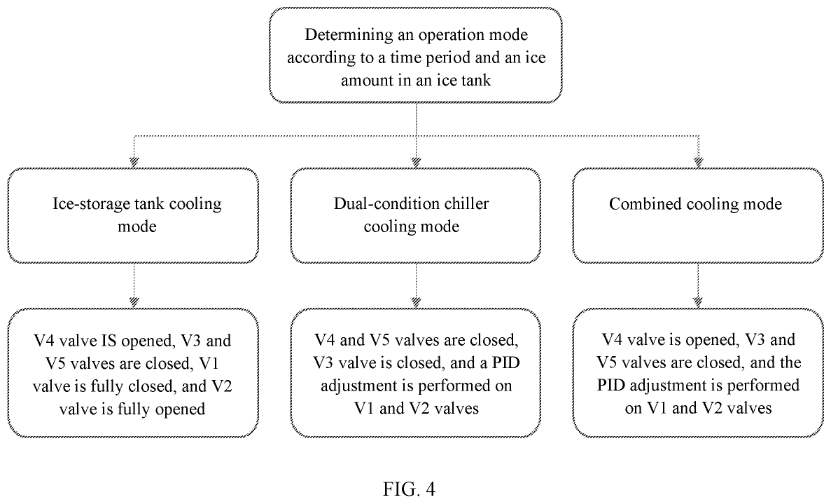

Referring to FIG. 4, a schematic diagram of determining the cooling mode of the ice storage system is shown. The ice storage air-conditioning system is determined to be in the dual-condition chiller cooling mode when the time period is in the power wave flat period or the ice amount in the ice storage tank is smaller than a lower threshold (that is, the first threshold, which may be 10%). As shown in FIG. 1, the V4 valve may be opened, the V3 and V5 valves are closed, the V1 valve is fully closed, and the V2 valve is fully opened.

The ice storage air-conditioning system is determined to be in the ice-storage tank cooling mode when the time period is in the power wave peak period and the ice amount in the ice storage tank is greater than a lower threshold (that is, the second threshold, which may be 10%). As shown in FIG. 1, the V4 valve may be opened, the V5 valve is closed, the V3 valve is closed, and a PID (Proportion Integration Differentiation) adjustment is performed on the V1 and V2 valves.

The ice storage air-conditioning system is determined to be in a combined cooling mode of a dual duty chiller and an ice storage tank when the time period is in the power wave peak period and the ice amount in the ice storage tank is smaller than a set threshold (i.e., the third threshold, which may be 30%), or the time period is in the power wave flat period and the ice amount in the ice storage tank is greater than a set threshold (i.e., the fourth threshold, which may be 80%). As shown in FIG. 1, the V4 valve may be opened, the V3 and V5 valves are closed, and the PID adjustment is performed on the V1 and V2 valves (an upper limit of the V1 valve is adjusted to 80%).

In step S304, parameters of the ice storage air-conditioning system in the current cooling mode may be adjusted based on an outlet temperature of a plate heat exchanger of the ice storage air-conditioning system.

Particularly, the parameters of the ice storage air-conditioning system are different under different cooling modes. For example, in case that the current cooling mode of the ice storage air-conditioning system is the dual-condition chiller cooling mode, steps for adjusting the parameters of the ice storage air-conditioning system in this cooling mode may include that: determining the number of operating water chilling units of the ice storage air-conditioning system based on an outlet water temperature and a current load rate of the ice storage air-conditioning system; determining the number of operating chilled water pumps of the ice storage air-conditioning system to be the same as the number of operating water chilling units; adjusting the operation frequency of the chilled water pump based on the outlet temperature of the plate heat exchanger of the ice storage air-conditioning system.

By way of example, when the time period is in the power wave flat period or the ice volume in the ice storage tank is smaller than the lower threshold (for example, 10%) the ice storage air-conditioning system is switched to operate in the dual-condition chiller cooling mode: the V4 valve is opened, the V3 and V5 valves are closed, the V1 valve is fully closed and the V2 valve is fully opened. Particularly, a target temperature of the ice storage air-conditioning system may be obtained. In accordance with a determination that the outlet temperature of the plate heat exchanger is greater than the sum of the target temperature and a preset first deviation value, increasing the operation frequency of the chilled water pump; and in accordance with a determination that the outlet temperature of the plate heat exchanger is smaller than a difference value between the target temperature and the first deviation value, reducing the operation frequency of the chilled water pump.

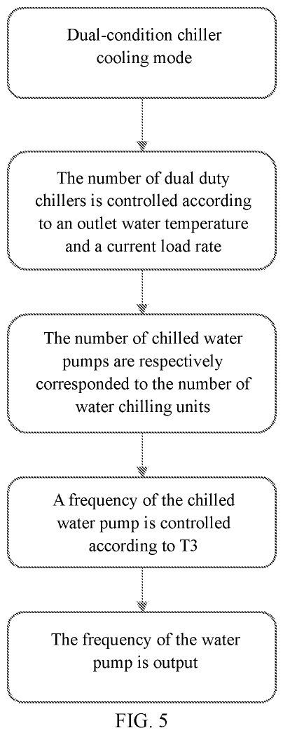

Referring to FIG. 5, which shows a schematic diagram of a control process for pumps and valves in a dual-condition chiller cooling mode. The dual duty chiller determines the number of operating water chilling units based on the outlet water temperature and the current load rate. The number of operating chilled water pumps is controlled corresponding to the number of operating water chilling units. The operation frequency of the chilled water pump is controlled according to the outlet temperature T3 of the plate heat exchanger (which may also be referred to as a plate exchanger outlet temperature). The frequency of the chilled water pump is increased when T3>a target value (i.e., target temperature)+a fixed deviation (i.e., first deviation value). The frequency of the chilled water pump is reduced when T3<a set value−the fixed deviation.

For another example, in case that the cooling mode of the ice storage air-conditioning system is the ice-storage tank cooling mode, steps for adjusting the parameters of the ice storage air-conditioning system in the cooling mode include at least one of the following: adjusting an opening degree of the valve of the ice storage tank in the ice storage air-conditioning system based on the outlet temperature of the plate heat exchanger of the ice storage air-conditioning system; adjusting the operation frequency of the chilled water pump based on the outlet temperature of the plate heat exchanger of the ice storage air-conditioning system; and adjusting the number of operating chilled water pumps based on the outlet temperature of the plate heat exchanger of the ice storage air-conditioning system.

By way of example, when the time period is in the power wave peak period and the ice amount in the ice storage tank is greater than the lower threshold (for example, 10%), the ice storage air-conditioning system is switched to operate in the ice-storage tank cooling mode: the V4 and V5 valves are opened, the V3 valve is closed, and the V1 and V2 valves are PID adjusted. Particularly, the opening degree of the valve of the ice storage tank is increased in accordance with a determination that the outlet temperature of the plate heat exchanger is greater than a sum of the target temperature and a preset second deviation value. The opening degree of the valve of the ice storage tank is reduced in accordance with a determination that the outlet temperature of the plate heat exchanger is smaller than a difference value between the target temperature and the second deviation value. The number of operating chilled water pumps is increased in accordance with a determination that the outlet temperature of the plate heat exchanger is greater than a sum of the target temperature and a preset third deviation value. The number of operating chilled water pumps is reduced in accordance with a determination that the outlet temperature of the plate heat exchanger is smaller than a difference value between the target temperature and the third deviation value.

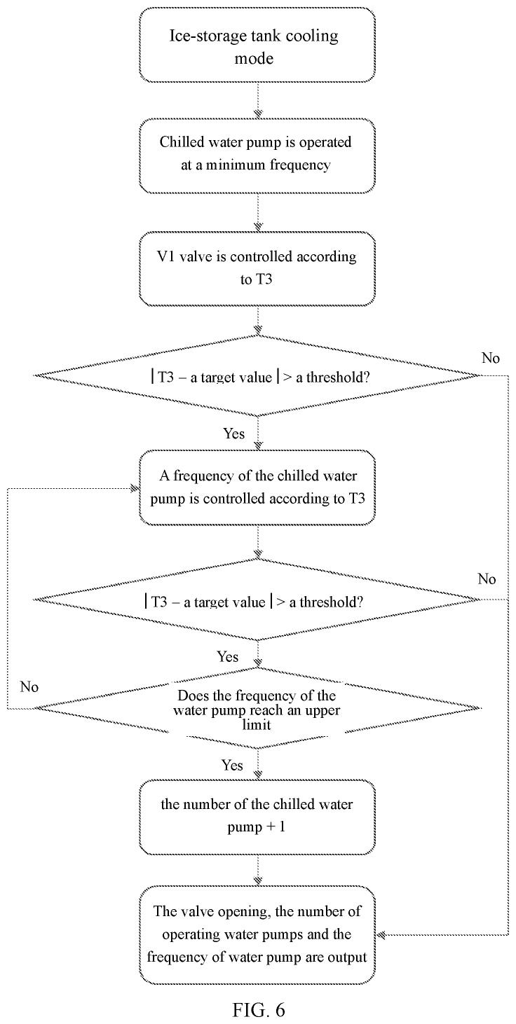

Referring to FIG. 6, which shows a schematic diagram of the control process for pumps and valves in an ice-storage tank cooling mode. The details of the pump-valve joint control method are as follows: 1) in case that the chilled water pump is operated at the set minimum frequency (30 Hz), then the V1 valve is adjusted based on the plate exchanger outlet temperature T3 as follows: the opening degree of the V1 valve is increased when T3>the target value+the fixed deviation (i.e., second deviation value); and the opening degree of the V1 valve is reduced when T3<the target value−the fixed deviation. 2) In case that the opening degree of the V1 valve reaches the set upper limit, then a frequency conversion control of the chilled water pump is started, and the operation frequency is adjusted based on the plate exchanger outlet temperature T3 as follows: the frequency of the chilled water pump is increased when T3>the target value+the fixed deviation (i.e., the third deviation value); and the frequency of the chilled water pump is reduced when T3<the target value−the fixed deviation. 3) In case that the chilled water pump frequency is adjusted to the upper limit (such as 50 Hz) and T3>the target value+the fixed deviation, then the number of operating chilled water pumps+1. In case that the frequency of the chilled water pump is adjusted to the lower limit (such as 30 Hz) and T3<the target value−the fixed deviation, then the number of operating chilled water pumps−1.

When the time period is in the power wave peak period and the ice volume in the ice storage tank is smaller than the set threshold (for example, 30%), or when the time period is in the power wave flat period and the ice volume in the ice storage tank is greater than the set threshold (for example, 80%), the ice storage air-conditioning system is switched to operate in the combined cooling mode of the dual duty chiller and the ice storage tank: the V4 valve is opened, the V3 and V5 valves are closed, and the V1 and V2 valves are PID adjusted (the upper limit of the V1 valve is adjusted to 80%).

For another example, in accordance with a determination that the current cooling mode of the ice storage air-conditioning system is the combined cooling mode of the dual duty chiller and the ice storage tank, then steps for adjusting parameters of the ice storage air conditioner in the current cooling mode based on the outlet temperature of the plate heat exchanger of the ice storage air-conditioning system include that: determining the number of operating water chilling units of the ice storage air-conditioning system based on the outlet water temperature and the current load rate of the ice storage air-conditioning system; determining the number of operating chilled water pumps of the ice storage air-conditioning system to be the same as the number of operating water chilling units; adjusting the opening degree of the valve of the ice storage tank in the ice storage air-conditioning system based on the outlet temperature of the plate heat exchanger of the ice storage air-conditioning system; and adjusting the operation frequency of the chilled water pump based on the outlet temperature of the plate heat exchanger of the ice storage air-conditioning system in accordance with a determination that the opening degree of the valve is adjusted to a preset limit of the opening degree.

Particularly, in accordance with a determination that the opening degree of the valve is adjusted to the preset limit of the opening degree, adjusting the operation frequency of the chilled water pump based on the outlet temperature of the plate heat exchanger of the ice storage air-conditioning system includes: increasing the operation frequency of the chilled water pump based on the outlet temperature of the plate heat exchanger of the ice storage air-conditioning system in accordance with a determination that the opening degree of the valve is increased to a preset upper limit of the opening degree; and reducing the operation frequency of the chilled water pump based on the outlet temperature of the plate heat exchanger of the ice storage air-conditioning system in accordance with a determination that the opening degree of the valve is reduced to a preset lower limit of the opening degree;

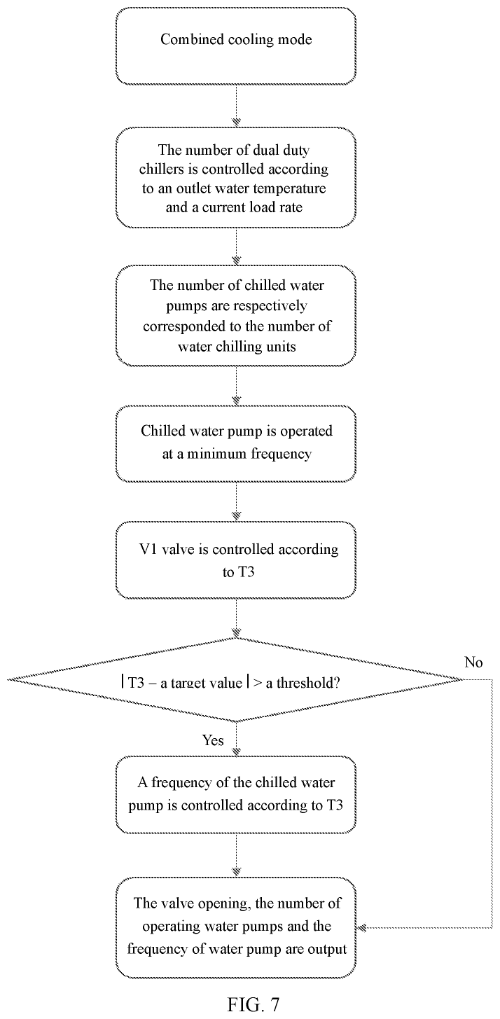

Referring to FIG. 7, which shows a schematic diagram of a control process for pumps and valves in a combined cooling mode of a dual duty chiller and an ice storage tank. The dual duty chiller determines the number of operating water chilling units based on a return water temperature and a current load rate. The number of operating chilled water pumps is controlled corresponding to the number of operating water chilling units. The details of the pump-valve joint control method are as follows: 1) the chilled water pump is operated at the set minimum frequency (30 Hz), and the V1 valve is adjusted according to the plate exchanger outlet temperature T3 as follows: the opening degree of the V1 valve is increased when T3>the target value+the fixed deviation (i.e., second deviation value); and the opening degree of the V1 valve is reduced when T3<the target value−the fixed deviation. 2) The opening degree of the V1 valve reaches the set upper limit, a frequency conversion control of the chilled water pump is started, and the operation frequency is adjusted according to the plate exchanger outlet temperature T3 as follows: the frequency of the chilled water pump increases when T3>the target value+the fixed deviation (i.e., the third deviation value); and the frequency of the chilled water pump reduces when T3<the target value−the fixed deviation.

In step S306, the ice storage air-conditioning system may be controlled to perform a cooling operation based on the adjusted parameters of the ice storage air-conditioning system.

The above method provided by the embodiment of the present disclosure proposes an intelligent and undisturbed method for controlling the ice storage air-conditioning system. First, under different operation modes, the target parameters of the ice tank inlet regulating valve and water pump frequency are set from multiple variables to unified variables, and a joint control of pumps and valves is achieved by means of a cascade control to ensure a stable control of the outlet temperature of the chilled water from the plate exchanger while minimizing the energy consumption of the chilled water pump.

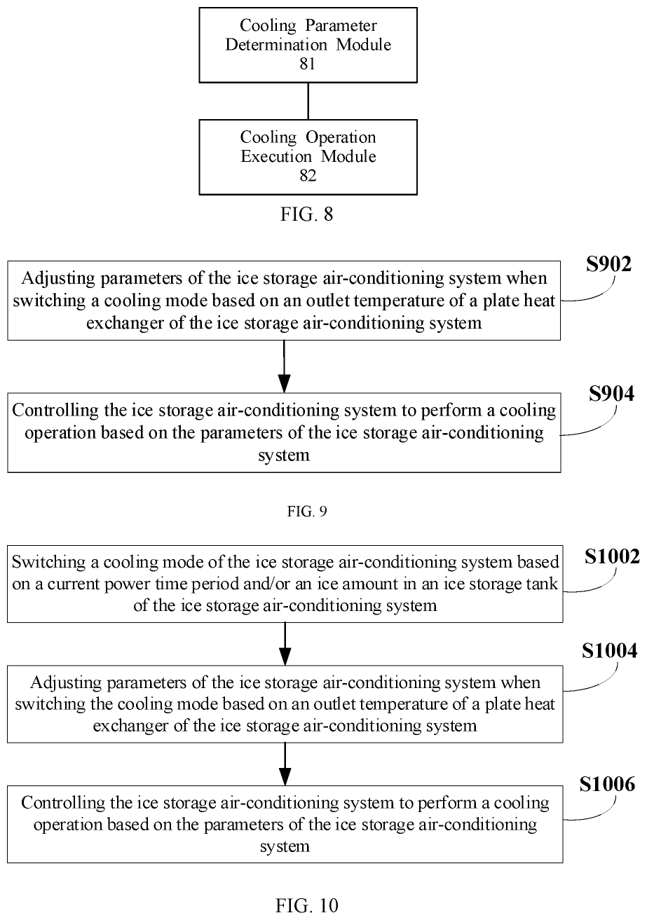

Corresponding to the method for controlling the ice storage air-conditioning system provided according to some embodiments of the present disclosure, embodiments of the present disclosure provide a device for controlling an ice storage air-conditioning system, which is applied to the controller of the ice storage air-conditioning system, Referring to FIG. 8, which shows a schematic structural diagram of a device for controlling an ice storage air-conditioning system, the device for controlling the ice storage air-conditioning system may include: a cooling parameter determination module 81 and a cooling operation execution module 82.

The cooling parameter determination module 81 is configured to adjust parameters of the ice storage air-conditioning system in a current cooling mode based on an outlet temperature of the plate heat exchanger of the ice storage air-conditioning system.

The cooling operation execution module 82 is configured to control the ice storage air-conditioning system to perform a cooling operation based on the parameters of the ice storage air-conditioning system.

The device for controlling the ice storage air-conditioning system provided by the embodiment of the present disclosure can adjust the current cooling mode based on the outlet temperature of the plate heat exchanger of the ice storage air-conditioning system, and control the ice storage air-conditioning system to perform the cooling operation based on the parameters of the ice storage air-conditioning system. In this control, the parameters of the ice storage air-conditioning system in the current cooling mode can be adjusted based on the outlet temperature of the plate heat exchanger, so that a stable outlet water temperature in the ice storage air-conditioning system can be ensured and the user's experience can be improved.

In case that the current cooling mode of the above ice storage air-conditioning system is the dual-condition chiller cooling mode, then the above cooling parameter determination module is configured to determine the number of operating water chilling units of the ice storage air-conditioning system based on the outlet water temperature and the current load rate of the ice storage air-conditioning system; determine the number of operating chilled water pumps of the ice storage air-conditioning system to be the same as the number of operating water chilling units; and adjust the operation frequency of the chilled water pump based on the outlet temperature of the plate heat exchanger of the ice storage air-conditioning system.

The above cooling parameter determination module is configured to obtain a target temperature of the ice storage air-conditioning system; increase the operation frequency of the chilled water pump in accordance with a determination that the outlet temperature of the plate heat exchanger is greater than a sum of the target temperature and a preset first deviation value; and, reduce the operation frequency of the chilled water pump in accordance with a determination that the outlet temperature of the plate heat exchanger is smaller than a difference value between the target temperature and the first deviation value.

In case that the current cooling mode of the above ice storage air-conditioning system is the ice-storage tank cooling mode, then the above cooling parameter determination module is at least configured for one of the following: adjusting an opening degree of the valve of the ice storage tank in the ice storage air-conditioning system based on the outlet temperature of the plate heat exchanger of the ice storage air-conditioning system; adjusting the operation frequency of the chilled water pump based on the outlet temperature of the plate heat exchanger of the ice storage air-conditioning system; and adjusting the number of operating chilled water pumps based on the outlet temperature of the plate heat exchanger of the ice storage air-conditioning system.

The above cooling parameter determination module is configured to: increase the opening degree of the valve of the ice storage tank in accordance with a determination that the outlet temperature of the plate heat exchanger is greater than a sum of the target temperature and a preset second deviation value; reduce the opening degree of the valve of the ice storage tank in accordance with a determination that the outlet temperature is smaller than a difference value between the target temperature and the second deviation value. The above cooling parameter determination module is configured to: increase the number of operating chilled water pumps in accordance with a determination that the outlet temperature of the plate heat exchanger is greater than a sum of the target temperature and a preset third deviation value; and reduce the number of operating chilled water pumps in accordance with a determination that the outlet temperature of the plate heat exchanger is smaller than the difference value between the target temperature and the third deviation value.

In case that the current cooling mode of the above ice storage air-conditioning system is the combined cooling mode of the dual duty chiller and the ice storage tank, then the above cooling parameter determination module is configured to determine the number of operating water chilling units of the ice storage air-conditioning system based on the outlet water temperature and the current load rate of the ice storage air-conditioning system; determine the number of operating chilled water pumps of the ice storage air-conditioning system to be the same as the number of operating water chilling units; adjust the opening degree of the valve of the ice storage tank in the ice storage air-conditioning system based on the outlet temperature of the plate heat exchanger of the ice storage air-conditioning system; and adjust the operation frequency of the chilled water pump based on the outlet temperature of the plate heat exchanger of the ice storage air-conditioning system in accordance with a determination that the opening degree of the valve is adjusted to a preset limit of the opening degree.

The above cooling parameter determination module is configured to: increase the operation frequency of the chilled water pump based on the outlet temperature of the plate heat exchanger of the ice storage air-conditioning system in accordance with a determination that the opening degree of the valve is increased to a preset upper limit of the opening degree; and reduce the operation frequency of the chilled water pump based on the outlet temperature of the plate heat exchanger of the ice storage air-conditioning system in accordance with a determination that the opening degree of the valve is reduced to a preset lower limit of the opening degree.

The above device also includes: a current cooling mode determination module, which is configured to determine a current cooling mode of the ice storage air-conditioning system based on a current power time period and/or an ice volume in the ice storage tank of the ice storage air-conditioning system.

The above current cooling mode determination module is configured to: determine that the current cooling mode of the ice storage air-conditioning system is a dual-condition chiller cooling mode in accordance with a determination that the current power time period is in a power wave flat period, or the ice amount in the ice storage tank of the ice storage air-conditioning system is smaller than a preset first threshold; determine that the current cooling mode of the ice storage air-conditioning system is the ice-storage tank cooling mode in accordance with a determination that the current power time period is in the power wave peak period and the ice amount in the ice storage tank of the ice storage air-conditioning system is greater than a preset second threshold; and determine that the current cooling mode of the ice storage air-conditioning system is the combined cooling mode of the dual duty chiller and the ice storage tank in accordance with a determination that the current power time period is in the power wave peak period and the ice amount in the ice storage tank of the ice storage air-conditioning system is smaller than a preset third threshold, or the current power time period is in the power wave flat period and the ice amount in the ice storage tank of the ice storage air-conditioning system is greater than a preset fourth threshold.

It can be clearly understood for persons skilled in the art that, for the convenience and simplicity of description, the specific working process of the device for controlling the ice storage air-conditioning system described above may be referred to the corresponding embodiments of the method for controlling the ice storage air-conditioning system, which will not be repeated in here.

The following describes in detail the method for controlling the ice storage air-conditioning system provided by other embodiments of the present disclosure with reference to FIGS. 9 to 12. The method for controlling the ice storage air-conditioning system particularly relates to an intelligent undisturbed switching method for controlling the ice storage air-conditioning system. This method can ensure a stable control of the outlet temperature of the chilled water from the plate exchanger while minimizing the energy consumption of the chilled water pump.

Referring to the flowchart of a method for controlling an ice storage air-conditioning system shown in FIG. 9, the method for controlling the ice storage air-conditioning system includes the following steps S902 and S904.

In step S902, parameters of the ice storage air-conditioning system are adjusted when switching a cooling mode based on an outlet temperature of a plate heat exchanger of the ice storage air-conditioning system.

In step S904, the ice storage air-conditioning system is controlled to perform a cooling operation based on the parameters of the ice storage air-conditioning system.

In the embodiment of the present disclosure, the parameters of the ice storage air-conditioning system when switching can be adjusted the cooling mode according to the outlet temperature of the plate heat exchanger of the ice storage air-conditioning system. Particularly, the parameters of the ice storage air-conditioning system may include an opening degree of each valve (i.e., the V1 valve to V5 valve in FIG. 1) and an operation frequency of a chilled water pump.

In step S904, the ice storage air-conditioning system may be controlled to perform the cooling operation based on parameters of the ice storage air-conditioning system.

After the parameters of the ice storage air-conditioning system are adjusted according to the outlet temperature of the plate heat exchanger, the ice storage air-conditioning system can be controlled according to the parameters of the ice storage air-conditioning system to perform the cooling operation, so as to ensure that the supply water temperature of the ice storage air-conditioning system has small fluctuations and improve the user's experience.

According to the method for controlling the ice storage air-conditioning system provided by the embodiment of the present disclosure, the parameters of the ice storage air-conditioning system when switching the cooling mode can be adjusted based on the outlet temperature of the plate heat exchanger of the ice storage air-conditioning system, and the ice storage air-conditioning system can be controlled to perform the cooling operation based on the parameters of the ice storage air-conditioning system. In this method, the parameters of the ice storage air-conditioning system when switching the cooling mode can be adjusted based on the outlet temperature of the plate heat exchanger, so that a stable outlet water temperature in the ice storage air-conditioning system can be ensured and the user's experience can be improved.

Referring now to FIG. 10. FIG. 10 shows another method for controlling the ice storage air-conditioning system provided according to an embodiment of the present disclosure, this method is implemented based on the embodiment shown in FIG. 9. with reference to the flowchart of another method for controlling the ice storage air-conditioning system shown in FIG. 10, the method for controlling the ice storage air-conditioning system in this embodiment may include the following steps S1002, S1004 and S1006.

In step S1002, a cooling mode of the ice storage air-conditioning system is switched based on a current power time period and/or an ice amount in an ice storage tank of the ice storage air-conditioning system.

In step S1004, parameters of the ice storage air-conditioning system are adjusted when switching the cooling mode based on an outlet temperature of a plate heat exchanger of the ice storage air-conditioning system.

In step S1006, the ice storage air-conditioning system is controlled to perform a cooling operation based on the parameters of the ice storage air-conditioning system.

According to the above embodiments of the present disclosure, a method for an intelligent undisturbed mode switching is provided, for example, the cooling mode of the ice storage air-conditioning system is switched from the dual-condition chiller cooling mode to the ice-storage tank cooling mode, or alternatively, the cooling mode of the ice storage air-conditioning system is switched from the ice-storage tank cooling mode to the dual-condition chiller cooling mode.

In the step S1004, the parameters of the ice storage air-conditioning system when switching the cooling mode may be adjusted based on the outlet temperature of the plate heat exchanger of the ice storage air-conditioning system.

For switching from the dual-condition chiller cooling mode to the ice-storage tank cooling mode, the following steps may be performed: maintaining a working status of the chilled water pump of the ice storage air-conditioning system, and adjusting a valve of the ice storage tank and a regulating valve of the plate heat exchanger in the ice storage air-conditioning system, among them, an opening degree of the valve of the ice storage tank and an opening degree of the regulating valve of the plate heat exchanger are determined both based on the outlet temperature of the plate heat exchanger; and switching off the water chilling units and cooling water pumps and cooling water towers of the ice storage air-conditioning system.

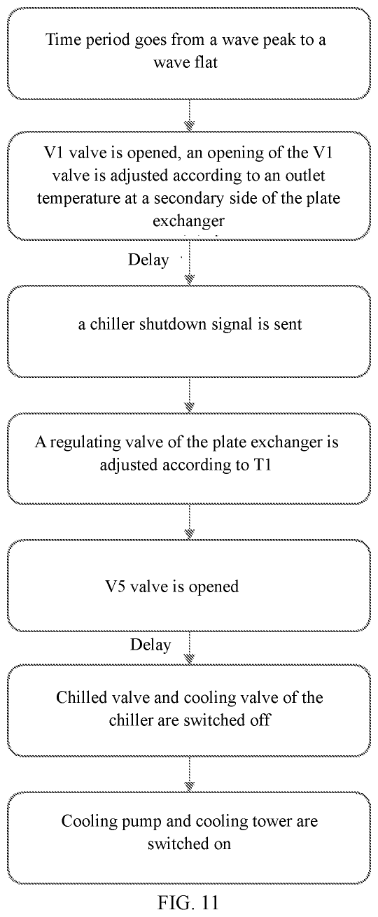

Referring to FIG. 11, which shows a schematic diagram of a control process for switching from a dual duty chiller cooling mode to an ice-storage tank cooling mode. The ice storage air-conditioning system is switched to operate in the ice-storage tank cooling mode when the time period is in the power wave peak period and the ice amount in the ice storage tank is greater than the lower threshold (for example, 10%). In order to ensure uninterrupted operation of cooling, the chilled water pump continues to operate. The controller may first open the V1 valve, and the opening degree of the V1 valve is adjusted according to the outlet temperature T3 of the secondary side of the plate exchanger. Secondly, a chiller shutdown signal is sent by the controller, and the regulating valve of the plate exchanger is adjusted according to T3. After the controller collects feedback that the chiller is shut down, the V5 valve is opened to allow the chilled water to flow directly into the ice tank. After a period of delay (usually set to 5 minutes), a chilled valve and a cooling valve of the chiller are closed respectively. After the cooling valve is closed in place, the cooling water pump and cooling water tower are closed in sequence. During the mode switch process, it can be ensured that a temperature fluctuation of T3 does not exceed ±0.5° C. as the V1 valve is PID adjusted based on the plate exchanger outlet temperature T3 all the time.

For switching from the ice-storage tank cooling mode to the dual-condition chiller cooling mode, the following steps may be performed: determining the number of operating water chilling units of the ice storage air-conditioning system after mode switching; switching on the number of operating water chilling units and cooling water pumps and cooling water towers; adjusting the opening degree of the valve of the ice storage tank in the ice storage air-conditioning system based on the outlet water temperature of the water chilling units and the outlet temperature of the plate heat exchanger.

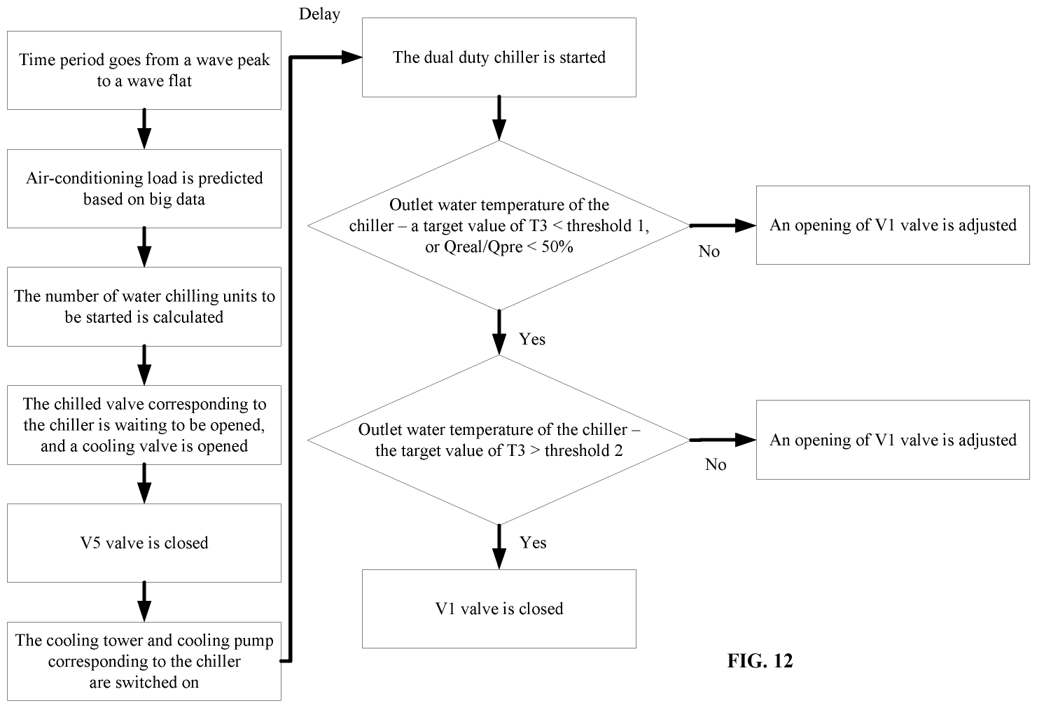

Referring to FIG. 12, which shows a schematic diagram of the control process of switching the ice-storage tank cooling mode to the dual-condition chiller cooling mode, the controller may establish an hourly load prediction model based on historical load data and outdoor weather data: Qₜ₊₁=f(Qₜ, T_{db,out,t}, R_{bout,t}, Sₜ), where t represents a current moment, t+1 represents a next moment, Q is an air conditioning load, T_{db,out,t} is an outdoor dry bulb temperature at the current moment, R_{h,out,t} is an outdoor relative humidity at the current moment, and Sₜ is a solar radiation intensity at the current moment.

Particularly, the number of operating water chilling units of the ice storage air-conditioning system after mode switching may be determined; the number of operating water chilling units, cooling water pumps and cooling water towers may be switched on; and the opening degree of the valve of the ice storage tank in the ice storage air-conditioning system may be adjusted based on the outlet water temperature of the water chilling unit and the outlet temperature of the plate heat exchanger.

The number of operating water chilling units of the ice storage air-conditioning system after mode switching can be determined through the following steps: obtaining a load before the mode switching of the ice storage air-conditioning system; determining a predicted load after the mode switching of the ice storage air-conditioning system based on the load before switching and a pre-established load prediction model; determining the number of operating water chilling units after the mode switching of the ice storage air-conditioning system based on the predicted load after the mode switching.

One hour before the time period of switching from the ice-storage tank cooling mode to the dual-condition chiller cooling mode, the BMS system first calculates a load of the current air conditioning system value based on a temperature difference T4-T3 of the return chilled water at the secondary side and a chilled water flow rate Mch at the secondary side, and then predict the air conditioning load for the next hour based on the above equation. At the same time, based on the predicted air-conditioning load and the dual duty chiller rated load, the number N of chillers that will be started at the next moment can be determined. In the time period of switching from the ice-storage tank cooling mode to the dual-condition chiller cooling mode, the BMS system issues control instructions based on the prediction results to switch on the chilled valve and cooling valve corresponding to the chiller to be started in advance. After the chilled valve and cooling valve of each chiller are switched on in place, the V5 valve is closed and the corresponding cooling water tower and cooling water pump of the chiller are switched on in sequence. After a period of delay (usually set to 5 minutes), the N dual duty chillers are started.

Particularly, the parameter adjustment may be performed through the following steps: obtaining an actual load of the ice storage air-conditioning system after mode switching; increasing the opening degree of the valve of the ice storage tank in the ice storage air-conditioning system if a value obtained by subtracting the outlet water temperature of the water chilling unit with the outlet temperature of the plate heat exchanger is greater than a preset first threshold, or a ratio of the predicted load and the actual load after the mode is switched is smaller than a preset ratio threshold; and reducing the opening degree of the valve of the ice storage tank in the ice storage air-conditioning system if the ratio of the predicted load and the actual load after the mode is switch is greater than the ratio threshold; and closing the valve of the ice storage tank of the ice storage air-conditioning system if an absolute value of the difference value between the outlet water temperature of the water chilling unit and the outlet temperature of the plate heat exchanger is smaller than a preset second threshold.

When the outlet water temperature of the chiller−a target value of T3≥a threshold 1 (set as 3° C.), or Qreal/Qpre<50% (the real cooling load/the predicted cooling load), it is indicated that the chiller is just loaded and the load rate of the chiller is relatively low and the outlet water temperature of the chiller is high, in this case, the PID adjustment is performed on the V1 valve according to T3, to ensure the stability of T3 temperature. When Qreal/Qpre>50%, it is indicated that the load of the chiller has reached a certain stage, in this case, the ice-storage tank will always bear part of the load if the upper limit of the V1 valve is not limited, and the load of the chiller cannot continue to be loaded. At this time, the opening degree of the valve of the ice storage tank in the ice storage air-conditioning system can be determined by the following formula:

V1,ub=(Tch,out−Tice,out)/(Tch,out−T3+Tcomp).

In the formula, V1,ub is the upper limit of the opening degree of the valve of the ice storage tank in the ice storage air-conditioning system, that is, the upper limit of the V1 valve, Tch,out is the outlet water temperature of the water chilling unit, Tice,out is the outlet water temperature of the ice storage tank, T3 is the outlet temperature of the plate heat exchanger, Tcomp is a preset compensation temperature, and Tcomp may reflect a temperature difference of the plate heat exchanger.

When |the outlet water temperature of the chiller−the target value of T3|<a threshold 2 (set to 0.5° C.), it is indicated that the dual duty chiller has dropped the water temperature to a required range, the V1 valve is closed, and the process of non-disruptive switching control is terminated.

In some embodiments, an intelligent undisturbed switching method for controlling the ice storage air-conditioning system is proposed. When a switching of the cooling mode is in need (switching from the ice-storage tank cooling mode to the dual-condition chiller cooling mode or switching from the dual-condition chiller cooling mode to the ice-storage tank cooling mode), the corresponding intelligent undisturbed switching control strategy is executed, which ensures that the fluctuation range of water temperature does not exceed ±0.5° C.

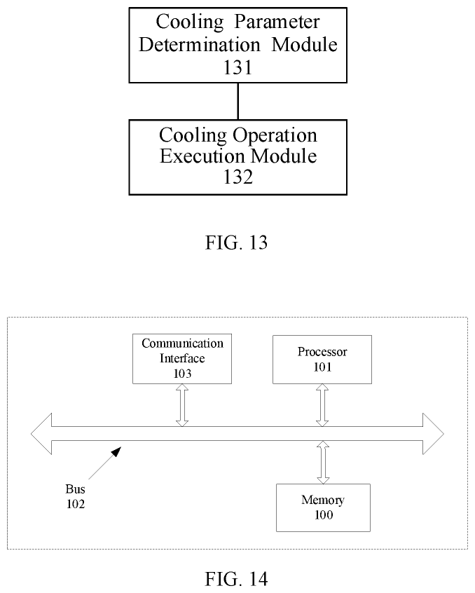

Corresponding to the method for controlling the ice storage air-conditioning system in other embodiments of the present application, embodiments of the present disclosure also provide a device for controlling an ice storage air-conditioning system, which is applied to the controller of the ice storage air-conditioning system, Referring to the schematic structural diagram of a device for controlling an ice storage air-conditioning system shown in FIG. 13, the device for controlling the ice storage air-conditioning system may include: a cooling parameter determination module 131 and a cooling operation execution module 132.

The cooling parameter determination module 131 is configured to adjust parameters of the ice storage air-conditioning system when switching a cooling mode based on an outlet temperature of a plate heat exchanger of the ice storage air-conditioning system.

The cooling operation execution module 132 is configured to control the ice storage air-conditioning system to perform a cooling operation based on the parameters of the ice storage air-conditioning system.

In some embodiments, the device for controlling the ice storage air-conditioning system may adjust the parameters of the ice storage air-conditioning system when switching the cooling mode based on the outlet temperature of the plate heat exchanger of the ice storage air-conditioning system, and the ice storage air-conditioning system can be controlled to perform the cooling operation based on the parameters of the ice storage air-conditioning system. In this method, the parameters of the ice storage air-conditioning system when switching the cooling mode can be adjusted based on the outlet temperature of the plate heat exchanger, so that a stable outlet water temperature in the ice storage air-conditioning system can be ensured and the user's experience can be improved.

In case that the cooling mode of the ice storage air-conditioning system is switched from the dual-condition chiller cooling mode to the ice-storage tank cooling mode, the above cooling parameter determination module is configured to maintain a working status of the chilled water pump of the ice storage air-conditioning system and adjust a valve of the ice storage tank and a regulating valve of the plate heat exchanger in the ice storage air-conditioning system, where an opening degree of the valve of the ice storage tank and an opening degree of the regulating valve of the plate heat exchanger are determined both based on the outlet temperature of the plate heat exchanger; and shutdown the water chilling units, cooling water pumps and cooling water towers of the ice storage air-conditioning system.

In case that the cooling mode of the ice storage air-conditioning system is switched from the ice-storage tank cooling mode to the dual-condition chiller cooling mode, the above cooling parameter determination module is configured to determine the number of operating water chilling units of the ice storage air-conditioning system after mode switching; switch on the number of operating water chilling units and cooling water pumps and cooling water towers; adjust the opening degree of the valve of the ice storage tank in the ice storage air-conditioning system based on an outlet water temperature of the water chilling unit and the outlet temperature of the plate heat exchanger.

The above cooling parameter determination module is configured to obtain a load before the mode switching of the ice storage air-conditioning system; determine a predicted load after the mode switching of the ice storage air-conditioning system based on the load before switching and a pre-established load prediction model; and determine the number of operating water chilling units after the mode switching of the ice storage air-conditioning system based on the predicted load after the mode switching.

The above cooling parameter determination module is configured to obtain an actual load of the ice storage air-conditioning system after the mode switching; increase the opening degree of the valve of the ice storage tank in the ice storage air-conditioning system in accordance with a determination that the outlet water temperature of the water chilling unit subtracted by the outlet temperature of the plate heat exchanger is greater than a preset first threshold, or a ratio of the predicted load to the actual load after the mode switching is smaller than a preset ratio threshold; reduce the opening degree of the valve of the ice storage tank in the ice storage air-conditioning system in accordance with a determination that the ratio of the predicted load to the actual load after the mode switching is greater than the ratio threshold; close the valve of the ice storage tank of the ice storage air-conditioning system in accordance with a determination that an absolute value of the difference value between the outlet water temperature of the water chilling unit and the outlet temperature of the plate heat exchanger is smaller than a preset second threshold.

The above cooling parameter determination module is configured to determine the opening degree of the valve of the ice storage tank in the ice storage air-conditioning system through the following formula: V1,ub=(Tch,out−Tice,out)/(Tch,out−T3+Tcomp); where, V1,ub is the upper limit of the opening degree of the valve of the ice storage tank in the ice storage air-conditioning system, Tch,out is the outlet water temperature of the water chilling unit, Tice,out is an outlet water temperature of the ice storage tank, T3 is the outlet temperature of the plate heat exchanger, and Tcomp is the preset compensation temperature.

The above device also includes: a cooling mode switching module, which is configured to switch the cooling mode of the ice storage air-conditioning system based on a current power time period and/or an ice amount in the ice storage tank of the ice storage air-conditioning system.

The above cooling mode switching module is configured to switch the cooling mode of the ice storage air-conditioning system from the dual-condition chiller cooling mode to the ice-storage tank cooling mode; or switch the cooling mode of the ice storage air-conditioning system from the ice-storage tank cooling mode to the dual-condition chiller cooling mode.

It can be clearly understood for persons skilled in the art that, for the convenience and simplicity of description, the specific working process of the device for controlling the ice storage air-conditioning system described above may be referred to the corresponding embodiments of the method for controlling the ice storage air-conditioning system, which will not be repeated in here.

An embodiment of the present disclosure also provides electronic equipment for executing the control method for the ice storage air-conditioning system. Referring to FIG. 14, a schematic structural diagram of the electronic equipment is shown, the electronic equipment includes a memory 100 and a processor 101. The memory 100 is configured to store one or more computer instructions, and the one or more computer instructions, when executed by the processor 101 enable(s) the method for controlling the ice storage air-conditioning system according to some embodiments of the present disclosure as described above and/or the method for controlling the ice storage air-conditioning system according to other embodiments of the present disclosure as described above to be implemented.

Further, the electronic equipment shown in FIG. 14 also includes a bus 102 and a communication interface 103. The processor 101, the communication interface 103 and the memory 100 are connected through the bus 102.

In this disclosure, the memory 100 may include a high-speed random-access memory (RAM, Random Access Memory), and may also include a non-volatile memory (non-volatile memory), such as at least one disk memory. The communication connection between the system network element and at least one other network element is realized through at least one communication interface 103 (which may be wired or wireless), and the Internet, wide area network, local network, metropolitan area network, etc. may be used. The bus 102 may be an ISA bus, a PCI bus, an EISA bus, etc. The bus may be divided into an address bus, a data bus, a control bus, etc. For ease of presentation, only one bidirectional arrow is used in FIG. 14, but it does not mean that there is only one bus or one type of bus.

The processor 101 may be an integrated circuit chip having signal processing capabilities. During an implementation process, each step of the above method may be completed by instructions in the form of hardware integrated logic circuits or software in the processor 101. The above processor 101 may be a general-purpose processor, including a central processing unit (Central Processing Unit, CPU for short), a network processor (Network Processor, NP for short), etc.; and may also be a digital signal processor (Digital Signal Processor, DSP for short).), an application specific integrated circuit (Application Specific Integrated Circuit, ASIC for short), a field-programmable gate array (Field-Programmable Gate Array, FPGA for short) or other programmable logic devices, discrete gate or transistor logic devices, and discrete hardware components. Each disclosed method, step and logical block diagram in the embodiment of the present disclosure may be implemented or executed. The general-purpose processor may be a microprocessor or the processor may be any conventional processor, etc. The steps of the method disclosed in conjunction with the embodiments of the present disclosure may be directly implemented by a hardware decoding processor, or executed by a combination of hardware and software modules in the decoding processor. The software module may be located in a random-access memory, a flash memory, a read-only memory, a programmable read-only memory or an electrically erasable programmable memory, a register and other mature storage media in this field. The storage medium is located in the memory 100. The processor 101 reads information in the memory 100 and completes steps of the method in the foregoing embodiment in combination with the hardware of the processor.

Embodiments of the present disclosure also provide a computer-readable storage medium in which computer-executable instructions are stored. When the computer-executable instructions are invoked and executed by the processor, the computer-executable instructions cause the processor to implement the method for controlling the ice storage air-conditioning system according to some embodiments of the present disclosure as described above and/or the method for controlling the ice storage air-conditioning system according to other embodiments of the present disclosure as described above. For specific implementation, reference may be made to the method embodiments, which will not be described in detail here.

The computer program products of the method for controlling the ice storage air-conditioning system, the device and the electronic equipment provided by some embodiments of the present disclosure include a computer-readable storage medium that stores a program code. The instructions included in the program code may be used to execute the method for controlling the ice storage air-conditioning system of some disclosed embodiments and/or the method for controlling the ice storage air-conditioning system according to other embodiments of the present disclosure as described above. For specific implementation, reference may be made to the method embodiments, which will not be described in detail here.

It can be clearly understood for persons skilled in the art that, for the convenience and simplicity of description, the specific working process of the device for controlling the ice storage air-conditioning system described above may be referred to the corresponding embodiments of the method for controlling the ice storage air-conditioning system, which will not be repeated in here.

In addition, in the description of the embodiments of the present disclosure, unless otherwise clearly stated and limited, the terms “installation”, “connection” and “coupled” should be understood in a broad sense. For example, it may be a fixed connection or a detachable connection, or being integrally connected; it may be a mechanical connection or an electrical connection; it may be a direct connection or an indirect connection through an intermediate medium; it may be an internal connection between two components. For persons of ordinary skill in the art, the specific meanings of the above terms in this disclosure can be understood on a case-by-case basis.

The functions, if implemented in the form of software functional units and sold or used as independent products, may be stored in a computer-readable storage medium. The computer software product is stored in a storage medium and includes several instructions configured to cause a computer device (which may be a personal computer, a server, or a network device, etc.) to execute all or part of the steps of the methods described in various embodiments of the present disclosure. The aforementioned storage media include: a U disk, a mobile hard disk, a read-only memory (ROM, Read-Only Memory), a random-access memory (RAM, Random Access Memory), a magnetic disk or n optical disk and other media that can store a program code.

In the description of the present disclosure, it should be noted that the orientation or positional relationship indicated by terms, such as “center”, “upper”, “lower”, “left”, “right”, “vertical”, “horizontal”, “inner”, “outer”, etc. is based on the orientation or positional relationship shown in the drawings, which is used only for the convenience of describing the present disclosure and simplifying the description and does not indicate or imply that the device or element referred to must have a specific orientation or be constructed or operated in a specific orientation, and thus should not be construed as limitations on the present disclosure. Furthermore, the terms “first”, “second” and “third” are used for descriptive purposes only and should not be construed as indicating or implying relative importance.

This application provides a method and a device for controlling an ice storage air-conditioning system, and electronic equipment. In the present application, the method is applied to a controller of the ice storage air-conditioning system. The method includes steps of: adjusting parameters of the ice storage air-conditioning system in a current cooling mode based on an outlet temperature of a plate heat exchanger of the ice storage air-conditioning system; and control the ice storage air-conditioning system to perform a cooling operation based on the parameters of the ice storage air-conditioning system. In this method, the parameters of the ice storage air-conditioning system in the current cooling mode can be adjusted based on the outlet temperature of the plate heat exchanger, thereby a stable outlet water temperature in the ice storage air-conditioning system can be ensure and the user's experience can be improved.

In addition, it should be understood that the method and device for controlling the ice storage air-conditioning system, and the electronic equipment of the present application are reproducible and can be used in a variety of industrial applications. For example, the method and device for controlling the ice storage air-conditioning system, and the electronic equipment of the present application can be applied to the technical field of air conditioning systems.

1. A method for controlling an ice storage air-conditioning system, comprising:
adjusting parameters of the ice storage air-conditioning system in a current cooling mode or when switching a cooling mode based on an outlet temperature of a plate heat exchanger of the ice storage air-conditioning system; and
controlling the ice storage air-conditioning system to perform a cooling operation based on the parameters of the ice storage air-conditioning system.

2. The method for controlling the ice storage air-conditioning system according to claim 1, wherein the current cooling mode of the ice storage air-conditioning system is a dual-condition chiller cooling mode; adjusting the parameters of the ice storage air-conditioning system in the current cooling mode based on the outlet temperature of the plate heat exchanger of the ice storage air-conditioning system comprises:
determining a number of operating water chilling units of the ice storage air-conditioning system based on an outlet water temperature and a current load rate of the ice storage air-conditioning system;
determining a number of operating chilled water pumps in the ice storage air-conditioning system to be the same as the number of operating water chilling units; and
adjusting an operation frequency of the chilled water pump based on the outlet temperature of the plate heat exchanger of the ice storage air-conditioning system.

3. The method for controlling the ice storage air-conditioning system according to claim 2, wherein adjusting the parameters of the ice storage air-conditioning system comprises:
obtaining a target temperature of the ice storage air-conditioning system;
in accordance with a determination that the outlet temperature of the plate heat exchanger is greater than a sum of the target temperature and a preset first deviation value, increasing the operation frequency of the chilled water pump; and
in accordance with a determination that the outlet temperature of the plate heat exchanger is smaller than a difference value between the target temperature and the preset first deviation value, reducing the operation frequency of the chilled water pump.

4. The method for controlling the ice storage air-conditioning system according to claim 1, wherein the current cooling mode of the ice storage air-conditioning system is an ice-storage tank cooling mode; adjusting the parameters of the ice storage air-conditioning system in the current cooling mode based on the outlet temperature of the plate heat exchanger of the ice storage air-conditioning system comprises at least one of the following:
adjusting an opening degree of a valve of an ice storage tank in the ice storage air-conditioning system based on the outlet temperature of the plate heat exchanger of the ice storage air-conditioning system;
adjusting an operation frequency of a chilled water pump based on the outlet temperature of the plate heat exchanger of the ice storage air-conditioning system; and
adjusting a number of operating chilled water pumps based on the outlet temperature of the plate heat exchanger of the ice storage air-conditioning system.

5. The method for controlling the ice storage air-conditioning system according to claim 4, wherein,
adjusting the opening degree of the valve of the ice storage tank in the ice storage air-conditioning system comprises:
in accordance with a determination that the outlet temperature of the plate heat exchanger is greater than a sum of a target temperature and a preset second deviation value, increasing the opening degree of the valve of the ice storage tank; and in accordance with a determination that the outlet temperature of the plate heat exchanger is smaller than a difference value between the target temperature and the preset second deviation value, reducing the opening degree of the valve of the ice storage tank; and
adjusting the number of operating chilled water pumps based on the outlet temperature of the plate heat exchanger of the ice storage air-conditioning system comprises:
in accordance with a determination that the outlet temperature of the plate heat exchanger is greater than a sum of the target temperature and a preset third deviation value, increasing the number of operating chilled water pumps; and in accordance with a determination that the outlet temperature of the plate heat exchanger is smaller than a difference value between the target temperature and the preset third deviation value, reducing the number of operating chilled water pumps.

6. The method for controlling the ice storage air-conditioning system according to claim 1, wherein the current cooling mode of the ice storage air-conditioning system is a combined cooling mode of a dual duty chiller and an ice storage tank, and adjusting the parameters of the ice storage air-conditioning system in the current cooling mode based on the outlet temperature of the plate heat exchanger of the ice storage air-conditioning system comprises:
determining a number of operating water chilling units of the ice storage air-conditioning system based on an outlet water temperature and a current load rate of the ice storage air-conditioning system;
determining a number of operating chilled water pumps of the ice storage air-conditioning system to be the same as the number of operating water chilling units;
adjusting an opening degree of a valve of an ice storage tank in the ice storage air-conditioning system based on the outlet temperature of the plate heat exchanger of the ice storage air-conditioning system; and
in accordance with a determination that the opening degree of the valve is adjusted to a preset limit of the opening degree, adjusting an operation frequency of the chilled water pump based on the outlet temperature of the plate heat exchanger of the ice storage air-conditioning system.

7. The method for controlling the ice storage air-conditioning system according to claim 6, wherein adjusting the operation frequency of the chilled water pump based on the outlet temperature of the plate heat exchanger of the ice storage air-conditioning system comprises:
in accordance with a determination that the opening degree of the valve is increased to a preset upper limit of the opening degree, increasing the operation frequency of the chilled water pump based on the outlet temperature of the plate heat exchanger of the ice storage air-conditioning system; and
in accordance with a determination that the opening degree of the valve is reduced to a preset lower limit of the opening degree, reducing the operation frequency of the chilled water pump based on the outlet temperature of the plate heat exchanger of the ice storage air-conditioning system.

8. The method for controlling the ice storage air-conditioning system according to claim 1, further comprising:
determining the current cooling mode of the ice storage air-conditioning system based on a current power time period and/or an ice amount in an ice storage tank of the ice storage air-conditioning system.

9. The method for controlling the ice storage air-conditioning system according to claim 8, wherein determining the current cooling mode of the ice storage air-conditioning system based on the current power time period and/or the ice amount in the ice storage tank of the ice storage air-conditioning system comprises:
in accordance with a determination that the current power time period is in a power wave flat period or the ice amount in the ice storage tank of the ice storage air-conditioning system is smaller than a preset first threshold, determining that the current cooling mode of the ice storage air-conditioning system is a dual-condition chiller cooling mode;
in accordance with a determination that the current power time period is in a power wave peak period, and the ice amount in the ice storage tank of the ice storage air-conditioning system is greater than a preset second threshold, determining that the current cooling mode of the ice storage air-conditioning system is an ice-storage tank cooling mode; and
in accordance with a determination that the current power time period is in the power wave peak period and the ice amount in the ice storage tank of the ice storage air-conditioning system is smaller than a preset third threshold, or the current power time period is in the power wave flat period and the ice amount in the ice storage tank of the ice storage air-conditioning system is greater than a preset fourth threshold, determining that the current cooling mode of the ice storage air-conditioning system is a combined cooling mode of a dual duty chiller and an ice storage tank.

10. The method for controlling the ice storage air-conditioning system according to claim 1, wherein, when the cooling mode of the ice storage air-conditioning system is switched from a dual-condition chiller cooling mode to an ice-storage tank cooling mode; adjusting the parameters of the ice storage air-conditioning system when switching the cooling mode based on the outlet temperature of the plate heat exchanger of the ice storage air-conditioning system comprises:
maintaining a working status of a chilled water pump of the ice storage air-conditioning system, and adjusting a valve of an ice storage tank in the ice storage air-conditioning system and a regulating valve of the plate heat exchanger; wherein an opening degree of the valve of the ice storage tank and an opening degree of the regulating valve of the plate heat exchanger are determined both based on the outlet temperature of the plate heat exchanger; and
switching off a water chilling unit, a cooling water pump and a cooling water tower of the ice storage air-conditioning system.

11. The method for controlling the ice storage air-conditioning system according to claim 1, wherein when the cooling mode of the ice storage air-conditioning system is switched from the ice-storage tank cooling mode to the dual-condition chiller cooling mode; adjusting the parameters of the ice storage air-conditioning system when switching the cooling mode based on the outlet temperature of the plate heat exchanger of the ice storage air-conditioning system comprises:
determining a number of operating water chilling units of the ice storage air-conditioning system after a mode switching;
switching on the number of operating water chilling units, cooling water pumps and cooling water towers; and
adjusting an opening degree of a valve of an ice storage tank in the ice storage air-conditioning system based on an outlet water temperature of the water chilling unit and the outlet temperature of the plate heat exchanger.

12. The method for controlling the ice storage air-conditioning system according to claim 11, wherein determining the number of operating water chilling units of the ice storage air-conditioning system after the mode switching comprises:
obtaining a load of the ice storage air-conditioning system before the mode switching;
determining a predicted load of the ice storage air-conditioning system after the mode switching based on the load before the mode switching and a pre-established load prediction model; and
determining the number of operating water chilling units of the ice storage air-conditioning system after the mode switching based on the predicted load after the mode switching.

13. The method for controlling the ice storage air-conditioning system according to claim 12, wherein, adjusting the opening degree of the valve of the ice storage tank in the ice storage air-conditioning system based on the outlet water temperature of the water chilling unit and the outlet temperature of the plate heat exchanger comprises:
obtaining an actual load of the ice storage air-conditioning system after the mode switching;
in accordance with a determination that a value obtained by subtracting the outlet water temperature of the water chilling unit with the outlet temperature of the plate heat exchanger is greater than a preset first threshold, or a ratio of the predicted load to the actual load after the mode switching is smaller than a preset ratio threshold, increasing the opening degree of the valve of the ice storage tank in the ice storage air-conditioning system;
in accordance with a determination that the ratio of the predicted load to the actual load after mode switching is greater than the preset ratio threshold, reducing the opening degree of the valve of the ice storage tank in the ice storage air-conditioning system; and
in accordance with a determination that an absolute value of a difference value between the outlet water temperature of the water chilling unit and the outlet temperature of the plate heat exchanger is smaller than a preset second threshold, closing the valve of the ice storage tank in the ice storage air-conditioning system.

14. The method for controlling the ice storage air-conditioning system according to claim 13, wherein reducing the opening degree of the valve of the ice storage tank in the ice storage air-conditioning system comprises:
determining the opening degree of the valve of the ice storage tank in the ice storage air-conditioning system through a following formula:
V1,ub=(Tch,out−Tice,out)/(Tch,out−T3+Tcomp);
wherein V1, ub is an upper limit of the opening degree of the valve of the ice storage tank in the ice storage air-conditioning system, Tch, out is the outlet water temperature of the water chilling unit, and Tice, out is an outlet water temperature of the ice storage tank, T3 is the outlet temperature of the plate heat exchanger, and Tcomp is a preset compensation temperature.

15. The method for controlling the ice storage air-conditioning system according to claim 1, further comprising:
switching a cooling mode of the ice storage air-conditioning system based on a current power time period and/or an ice amount in an ice storage tank of the ice storage air-conditioning system.

16. The method for controlling the ice storage air-conditioning system according to claim 15, wherein switching the cooling mode of the ice storage air-conditioning system comprises:
switching the cooling mode of the ice storage air-conditioning system from a dual-condition chiller cooling mode to an ice-storage tank cooling mode; or
switching the cooling mode of the ice storage air-conditioning system from the ice-storage tank cooling mode to the dual-condition chiller cooling mode.

17. An electronic device, comprising: a processor and memory storing one or more programs, the one or more programs comprising instructions that, when executed by the one or more processors, cause the processor to perform operations comprising:
adjusting parameters of the ice storage air-conditioning system in a current cooling mode or when switching a cooling mode based on an outlet temperature of a plate heat exchanger of the ice storage air-conditioning system; and
controlling the ice storage air-conditioning system to perform a cooling operation based on the parameters of the ice storage air-conditioning system.

18. The electronic device according to claim 17, wherein the current cooling mode of the ice storage air-conditioning system is a dual-condition chiller cooling mode; adjusting the parameters of the ice storage air-conditioning system in the current cooling mode based on the outlet temperature of the plate heat exchanger of the ice storage air-conditioning system comprises:
determining a number of operating water chilling units of the ice storage air-conditioning system based on an outlet water temperature and a current load rate of the ice storage air-conditioning system;
determining a number of operating chilled water pumps in the ice storage air-conditioning system to be the same as the number of operating water chilling units; and
adjusting an operation frequency of the chilled water pump based on the outlet temperature of the plate heat exchanger of the ice storage air-conditioning system.

19. A non-transitory computer-readable storage medium, storing a computer program, the computer program, when executed by a processor of an electronic device, cause the processor to perform operations comprising:
adjusting parameters of the ice storage air-conditioning system in a current cooling mode or when switching a cooling mode based on an outlet temperature of a plate heat exchanger of the ice storage air-conditioning system; and
controlling the ice storage air-conditioning system to perform a cooling operation based on the parameters of the ice storage air-conditioning system.

20. The non-transitory computer-readable storage medium according to claim 19, wherein the current cooling mode of the ice storage air-conditioning system is a dual-condition chiller cooling mode; adjusting the parameters of the ice storage air-conditioning system in the current cooling mode based on the outlet temperature of the plate heat exchanger of the ice storage air-conditioning system comprises:
determining a number of operating water chilling units of the ice storage air-conditioning system based on an outlet water temperature and a current load rate of the ice storage air-conditioning system;
determining a number of operating chilled water pumps in the ice storage air-conditioning system to be the same as the number of operating water chilling units; and
adjusting an operation frequency of the chilled water pump based on the outlet temperature of the plate heat exchanger of the ice storage air-conditioning system.
